(19) United States
(12) Patent Application Publication
(10) Pub. No.: US 2014/0007215 A1
(43) Pub. Date: Jan. 2, 2014

(54) MOBILE APPLICATIONS PLATFORM

(71) Applicant: Lockheed Martin Corporation, Bethesda, MD (US)

(72) Inventors: Anthony Romano, King of Prussia, PA (US); Shawn Matthew Dahlen, Malvern, PA (US); William P. Opet, Philadelphia, PA (US); Stephen G. Terlecki, King of Prussia, PA (US); Brian H. Mayo, Wayne, PA (US); Christopher S. Keohane, Wayne, PA (US)

(21) Appl. No.: 13/918,880

(22) Filed: Jun. 14, 2013

Related U.S. Application Data
(60) Provisional application No. 61/660,655, filed on Jun. 15, 2012.

(51) Int. Cl. H04L 29/06

(52) U.S. Cl. CPC H04L 63/0281
USPC 726/12

(57) ABSTRACT

Systems, methods and computer program products for securely accessing enterprise data and services using a mobile device in a BYOD environment. In one embodiment, a system for securely accessing enterprise data and services may include a mobile device, a container application installed on the mobile device, and an application browser embedded in the container application that is capable of requesting and executing enterprise web applications. The container application may also be capable of encrypting cache and local storage and securing a communications channel to a proxy server.

### RELATED APPLICATION INFORMATION

This application claims priority from U.S. Provisional Application Ser. No. 61/660,655, entitled “MOBILE APPLICATIONS PLATFORM” filed on Jun. 15, 2012, which is incorporated by reference herein in its entirety.

### BACKGROUND OF THE INVENTION

Employees want mobile access to critical corporate email, calendar, contacts, applications and Intranet from their personally owned smartphones, tablets and other mobile devices, without compromising the privacy of their personal data and device capabilities. Enterprises want to promote greater productivity and extend the corporate Intranet to such mobile devices, but need to manage mobility to protect sensitive information.

An environment in which employees are able to access data and services of an enterprise information technology system using personally owned devices is sometimes referred to as a Bring Your Own Device (BYOD) environment. Many existing BYOD solutions generally require installing email, calendar, contacts, and other applications to the personally owned mobile device in order to access corresponding enterprise data and/or services, thus making the corresponding enterprise data and/or services available to any user of the mobile device and more susceptible to attacks and data being compromised.

### SUMMARY OF THE INVENTION

Accordingly, the present disclosure generally provides systems and methods for securely accessing enterprise data and services using a mobile device. Accordingly, a mobile applications platform including a container application is provided to facilitate secure access to enterprise data and services in a BYOD environment. The container application may comprise a native application that may be installed on a mobile device and may include a protected web browser capable of requesting and executing enterprise web applications. The container application may also be capable of encrypting cache and local storage and securing a communications channel to a server endpoint. The container application provides a boundary for separation of personal and enterprise data. The container application may be optimized (e.g., navigation, bookmarking, integration with native hardware) for interaction with HTML5 web applications.

Embodiments described herein of a system for securely accessing enterprise data and services may include a mobile device, a container application installed on the mobile device, and an application browser embedded in the container application. The container application may be executable by a processor of the mobile device to securely connect the mobile device for communication with a proxy server included in an enterprise information technology system. The proxy server may map one or more web applications included in the enterprise information technology system for access by the application browser. The container application may launch the embedded application browser to request from the proxy server at least one of the one or more web applications for execution by the embedded application browser within the container application. The container application may also encrypt data associated with the at least one of the one or more web applications and stored locally on the mobile device. In this regard, the container application provides a boundary on the mobile device for separation of personal and enterprise data and services.

Embodiments described herein of a method for securely accessing enterprise data and services may include securely connecting a mobile device for communication with a proxy server included in an enterprise information technology system using a container application installed on the mobile device. The container application may include an embedded application browser that is launched to request from the proxy server at least one of one or more web applications included in the enterprise information technology system. In this regard, the proxy server may map one or more web applications included in the enterprise information technology system for access by the application browser. The method may also include executing on the mobile device the requested at least one of the one or more web applications with the application browser embedded within the client container application. The method may further include encrypting with the container application data associated with the executed at least one of the one or more web applications and stored locally on the mobile device. In this regard, the container application provides for a boundary on the mobile device for separation of personal and enterprise data and services.

Advantages achieved by the mobile applications platform system and method include, for example, the following: (1) Provides employees mobile access to critical corporate email, calendar, contacts, applications and Intranet from their personally owned smartphones, tablets and other mobile devices, without compromising the privacy of their personal data and device capabilities; (2) Implements policies that manage and protect enterprise data while abstracting enterprise policy from the personally owned device; and (3) Closes the user experience gap between web-based and native applications.

Various refinements exist of the features noted in relation to the various aspects of the present disclosure. Further features may also be incorporated in the various aspects of the present disclosure. These refinements and additional features may exist individually or in any combination, and various features of the various aspects may be combined. These and other aspects and advantages of the present invention will be apparent upon review of the following Detailed Description when taken in conjunction with the accompanying figures.

### BRIEF DESCRIPTION OF THE DRAWINGS

FIG. 1 is a schematic representation of a system for securely accessing enterprise data and services using a mobile device.

FIG. 2 is a schematic representation of an exemplary mobile device.

FIG. 3 is a schematic representation of the system of FIG. 1 and further additional components that may be included in one example of a system for securely accessing enterprise data and services using a mobile device.

FIG. 4 illustrates one embodiment of an application request interception and authentication process.

FIG. 5 illustrates one embodiment of an endpoint validation and authentication provider process.

FIG. 6 illustrates one embodiment of an offline application policy enforcement process.

FIG. 7 illustrates one embodiment of a process of intercepting local storage requests.

FIG. 8 illustrates one embodiment of a process of intercepting application requests.

### DETAILED DESCRIPTION

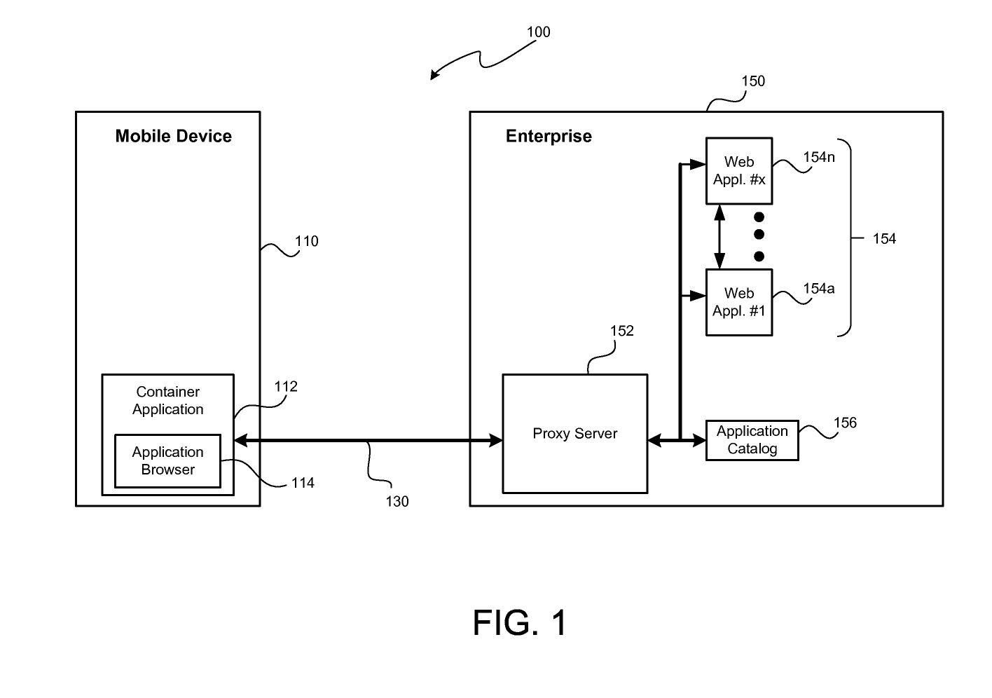

FIG. 1 shows a system 100 for securely accessing enterprise data and services, according to various embodiments. The system 100 may include a mobile device 110, a container application 112, and an application browser 114. The mobile device 110 may be any portable device suitable for providing users of such device secure and remote access, and/or access on the go, to enterprise data and services. Examples of such mobile devices 110 include smartphones, tablets, and personal digital assistants (PDAs), to name a few.

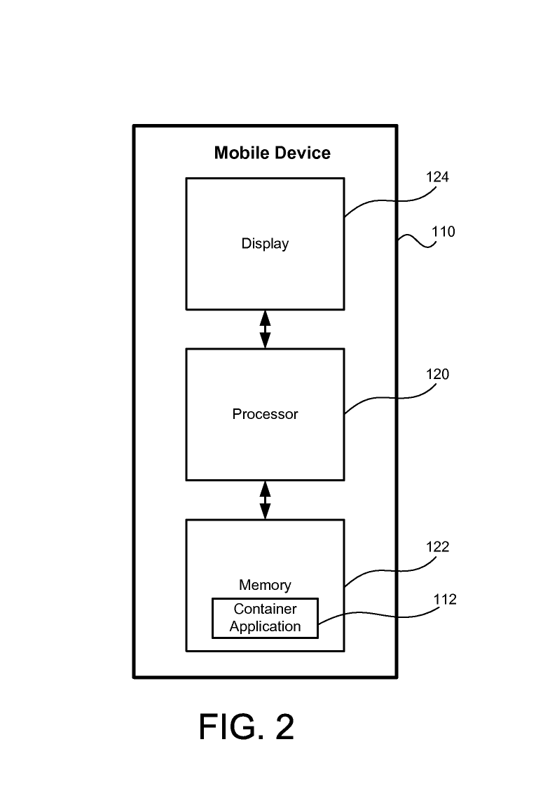

As shown in FIG. 2, the mobile device 110 may include at least one processor 120, a memory 122 and a display 124. The memory 122 may store the container application 110 which may be executed by the processor 120. In this regard, the container application 110 may be in the form of computer executable program code, which may initially be stored on a non-transitory computer readable medium for installation onto the memory 122 of the mobile device 110 (e.g., by downloading the computer executable program code from a server). The display 124 may display data and applications to a user of the mobile device 110 and may also comprise a touchscreen enabled to receive input from the user. The mobile device 110 may include additional components not illustrated in FIG. 2 including, for example, a keyboard or keypad operable to receive user input, one or more transceivers for sending and receiving data, and a battery for providing power to operate the processor 120 and other components of the mobile device 110.

The container application 112 may be operable to securely connect the mobile device 110 for data communications with a proxy server 152. The proxy server 152 may be part of an enterprise information technology system 150. The enterprise information technology system 150 may be referred to herein simply as the enterprise 150. Enterprise 150 may include data, services, applications, security, authentication, and authorization capabilities, to name a few. The system 100 may further include a private network 130 for securely communicating data between the container application 112 and the proxy server 152. In one example, the private network 130 may be a virtual private network.

The container application 112 may be installed and run on the mobile device 110 (e.g., by the processor 120). The application browser 114 may be embedded in the container application 112 and may be designed and/or optimized for accessing HTML5 web content. The application browser 114 may also be referred to herein as the embedded web browser 114.

The container application 112 may be enabled to access one or more enterprise web applications 154 via launching one or more of the web applications 154 within the embedded application browser 114. In this regard, the web applications may comprise HTML5 applications. Each enterprise web application 154a-154n may be discovered via an application catalog (e.g., application store) accessible through the embedded application browser 114. Upon discovering an enterprise web application 154, users are able to “install” a web application 154 by registering a bookmark associated with the web application 154 into the application browser 114. The enterprise application catalog may be filtered based on, for example, user identity or enterprise group association.

The container application 112 may store one or more Enterprise web applications 154 locally within the container application 112. In this regard, the container application 112 may encrypt data associated with the one or more enterprise web applications 154 and stored locally on the memory 122 of the mobile device 110. As such, the locally stored Enterprise web applications 154 may be accessed upon user authentication and verification.

In addition to locally stored Enterprise web applications 154 being accessible upon user authentication and verification, the Enterprise proxy server 152 may be accessible only via the container application 112. As such, accessing the Enterprise proxy server 152 may require user authentication and verification. In this regard, the container application 112 may manage authentication and verification of a user of the mobile device 110. For example, access to the proxy server 152 may be protected with a complex password and all data stored within application browser 114 may be containerized and encrypted. Access to all enterprise web applications 154 may be controlled through integrated (e.g., proxied) authorization resulting in single sign on to the enterprise web applications 154 once authenticated to application browser 114.

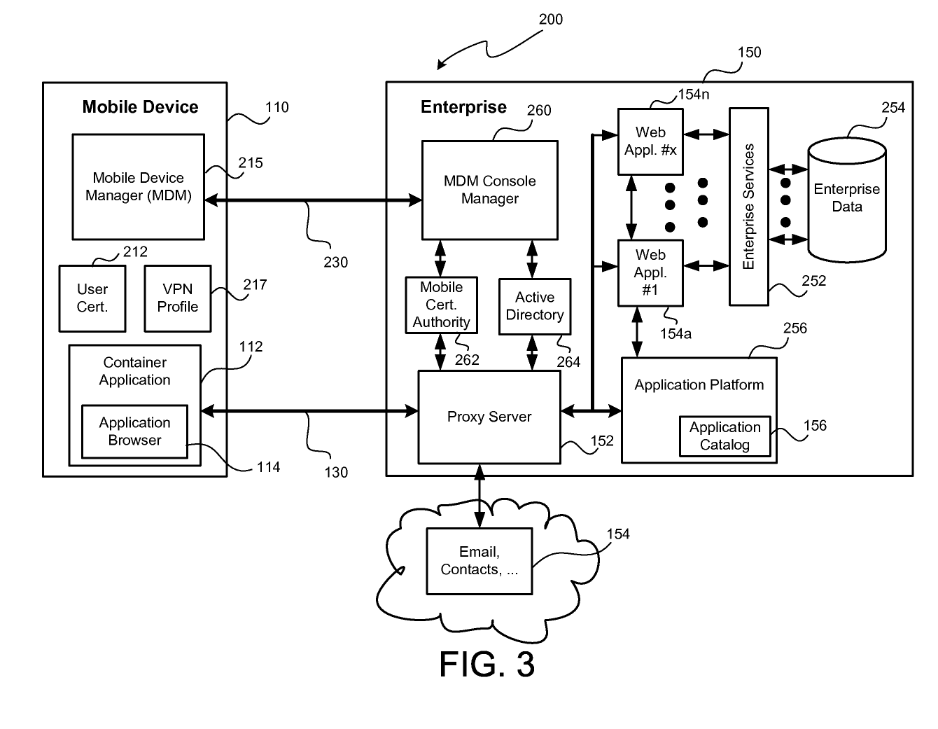

FIG. 3 shows a system 200 for securely accessing enterprise data and services, according to various embodiments. The system 200 includes mobile device 110, a container application 112, an application browser 114, and an enterprise 150, all of which may include features similar to those as described herein in connection with the system 100 of FIG. 1 and exemplary mobile device 110 of FIG. 2.

System 200 may also include additional features. For example, the mobile device 110 may include a mobile device manager (MDM) 215. MDM 215 may be stored in the memory 122 of the mobile device 110 for execution by the processor 120 of the mobile device 110. In this regard, MDM 215 may be in the form of computer executable program code, which may initially be stored on a non-transitory computer readable medium for installation onto the memory 122 of the mobile device 110 (e.g., by downloading it from a server).

The MDM 215 may be configured to manage a virtual private network (VPN) profile 217, user certificates 212, encrypted data stored on the memory 122 of the mobile device 110, and detect if and/or when the mobile device 110 has been jailbroken or rooted. As such, if and/or when the mobile device 110 has been jailbroken or rooted, the MDM 215 may delete the container application 112.

In system 200, the enterprise 150 may also include enterprise services 252, enterprise data 254, an application platform 256, and an MDM console manager 260. The MDM console manager 260 may be configured to register the mobile device 110 and manage the MDM 215. In this regard, a secure MDM communication channel 230 may be provided between the MDM 215 and the MDM console manager. The MDM console manager 260 may connect to a certificate authority 262 and an active directory 264 to create user certificates.

The application platform 256 may be configured to establish a secure endpoint within the private network 130 through which applications in the application browser 114 may make secure requests. The application platform 256 may authenticate and proxy requests for applications registered in an application catalog 266.

Data within the container application 112 and transport of data (e.g., wirelessly) from the application browser 114 to the enterprise 150 (e.g., the enterprise proxy server 152) may be protected. The data securely communicated between the container application 112 and the enterprise proxy server 152 may include data associated with the one or more enterprise web applications 154. The data securely communicated between the container application 112 and the enterprise proxy server 152 may also include data associated with authentication and verification of a user of the mobile device 110. For example, requests for a web application 154 originating from the mobile device 110 may be communicated via private network 130 and carry an application browser 114 identity certificate 212. In order to access enterprise services 252, the application platform 256 may translate the identity certificate 212 into a Kerberos credential. The Kerberos credential may allow the application platform 256 to make requests and authenticate on behalf of the user of the mobile device 110 via the user's enterprise identity. This may facilitate single sign at the application browser 114 on the mobile device 110 into enterprise 150.

A user of the mobile device 110 may be required to register and activate the application browser 114 in order to connect to the proxy server 152. After the application browser 114 has been installed, the application browser 114 may download and install an Enterprise configuration profile and provide public certificates to Enterprise servers. The application browser 114 may classify the integrity of the mobile device 110 using Jailbreak Detection. The application browser 114 may automatically create a public and private key. Each instance of the application browser 114 may be given a unique identifier called an app token.

The application browser 114 may prompt a user of the mobile device 110 to enter a passcode/word. This passcode/word may be sent to the MDM 215 along with the app token where it may be validated against a local passcode/word data store. Once the passcode/word is validated, it is marked as used and logged along with the app token in the data store so that it cannot be used again. When the secure gateway validates the passcode/word, the user identification that is associated with the passcode/word will be returned to the application browser 114 to be used as the subject in the certificate signing request required for the identity certificate.

If the user entered passcode/word is not found in the secure gateway's local passcode/word data store, or has expired, the failed activation attempt will be logged and the passcode/word will be disabled. The user will be notified and will be required to start the registration process again. The user will be referred to their activation e-mail for instructions of how to proceed.

The application browser 114 will use the subject supplied from the passcode/word validation request along with the private key created earlier to generate a certificate signing request (CSR). The CSR is submitted to the Security Gateway along with the app token generated by the application browser 114. The Security Gateway performs a quick filter on the request to sign the CSR by checking the app token with the local app token white list before forwarding the request over to the application browser platform 256. The application browser platform 256 takes the subject included in the CSR and validates it against the passcode/word data store using the app token to ensure that the request is authentic. The application browser platform 256 then contacts the enterprise certificate authority via certificate management protocol (CMP) and signs the CSR to generate the X.509 identity certificate. The identity certificate is return to the app browser.

When the signed identity certificate is returned to the app browser, the user is prompted for a strong password. That password is stretched using the password based key derivation function (PBKDF2). The PBKDF2 mechanism uses the app token as a seed and HMAC-SHA256 for its cryptographic function. This strong password is used to secure the PKCS #12 file that contains the identity certificate and the private key.

Upon receipt and storage of the identity certificate, the application browser 114 uses the fingerprint from the identity certificate as the final piece to the app token. This complete app token is sent to the Secure Gateway using the identity certificate as authentication to the Secure Gateway. The Secure Gateway then forwards on the activated app token to the application browser platform 256 where it is stored and the registration/activation process is complete.

The Secure Gateway is responsible for validating the registration passcode/words before passing the registration and activation requests over to the application browser platform 256. The Secure Gateway maintains a current list of passcode/words and fully activated App Tokens by periodically polling the application browser platform 256 for updates.

The application browser platform 256 remains the record of authority during the registration and activation process. All passcode/words, app tokens, and activated app tokens are stored within the application browser platform 256 along with the associated user information provided when a welcome email was sent to the user.

The application browser 114 facilitates establishing a secure communications channel through the Security Gateway to the application browser platform 256. This channel is used for requests made by the apps hosted in the application browser 114 to endpoints located in the intranet.

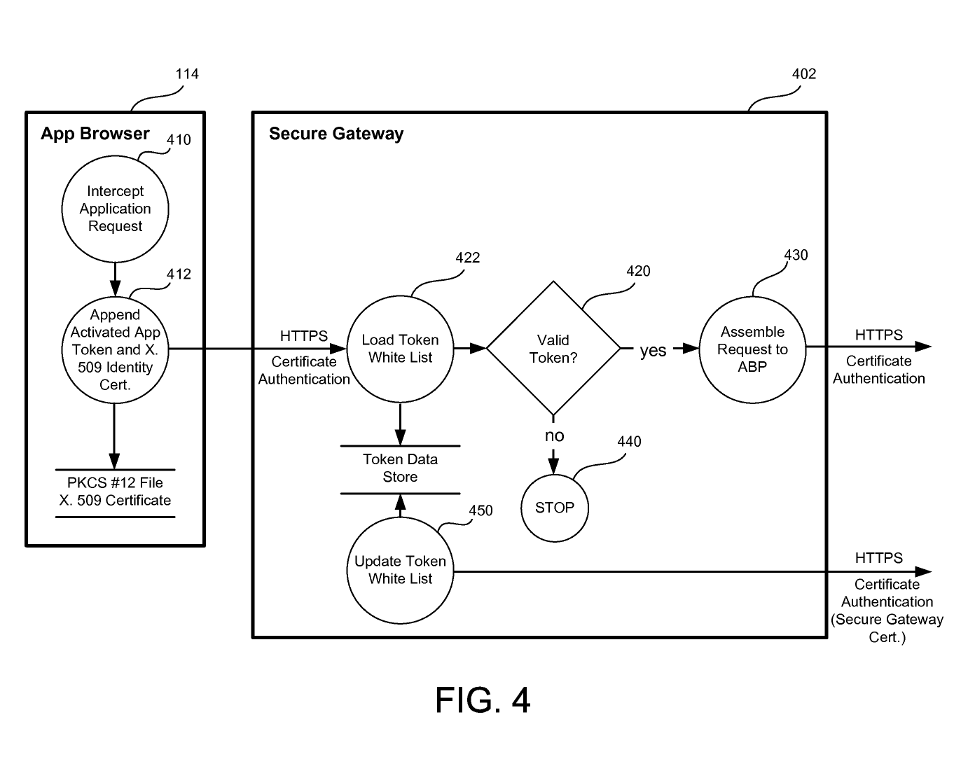

Referring to FIG. 4, any requests made by applications within the application browser 114 are intercepted 410 and routed through the Secure Gateway 402 to be handled by the application browser platform 256. The application browser 114 may attach 412 an App Token (e.g., in one embodiment) and an Identity Certificate to ensure non-repudiation for all requests that are made to the Secure Gateway 402 and later on to the application browser platform 256.

In an embodiment where an App Token is attached, the Secure Gateway 402 may look at the App Token and may validate 420 it against the local white list 422 of valid App Tokens that is synched with the application browser platform 256. If the App Token is listed as valid, it may be passed 430 on to the application browser platform 256. If the Secure Gateway determines that the App Token is not valid, the attempted connection may be logged and the request may be denied 440. In some embodiments (e.g., where no App Token is attached) validating an App Token against the local white list and passing it on to the application browser platform may not be undertaken. In this regard verification may be based on a digital signature of the certificate.

On an independent schedule, the Secure Gateway pods the application browser platform 256 at regular intervals to keep the App Token white list up to date 450.

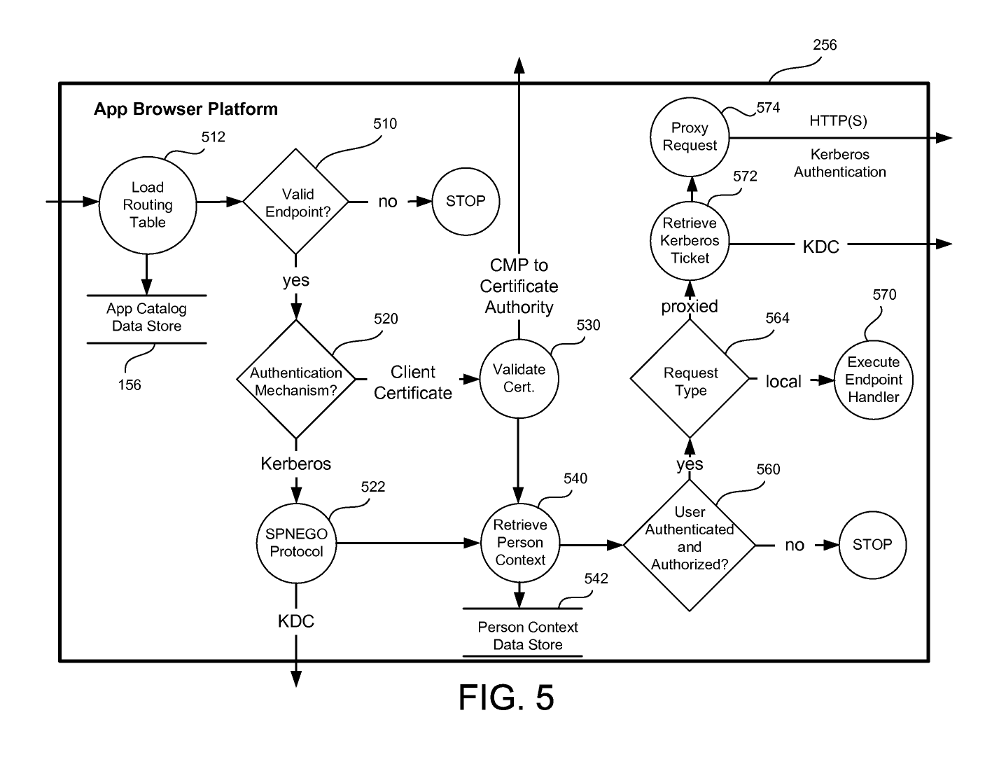

Referring to FIG. 5, each request made to the application browser platform 256 will be checked 510 against the routing table 512 stored in the application catalog 156 data store. The application catalog 156 contains the list of registered applications and their associated end points. All requests need to match an end point pattern in the application catalog 156 before moving on in the application browser platform 256. When a pattern is matched, the request context is updated with information about the application destination including the authentication mechanism 520.

Since the application browser platform 256 will service requests from the Secure Gateway 402 as well as requests that originated within the Intranet, multiple authentication mechanisms need to be supported. Requests originating in the intranet will be required to authenticate using Kerberos via the SPNEGO protocol 522. Requests from the Secure Gateway can come in two flavors: application browser 114 Identity Certificate or Secure Gateway Identity Certificate. In the case of App Registration and Activation, an individual application browser 114 will not have a complete App Token and Identity Certificate, so the application browser platform 256 will support authentication from the Secure Gateway using an Identity Certificate specifically for its use on behalf of unactivated application browsers. The Secure Gateway Identity Certificate will also be used for authenticating requests to the application browser platform 256 to sync local data stores.

Identity Certificate authentication requires validation 530 against the Certificate Authority used to sign the certificate request. Once the Identity Certificate is validated, the subject is pulled out and may be used to authenticate the request.

In the scenario of an intranet originated request, the SPNEGO protocol would be used to challenge the caller for a Kerberos Ticket which is then used to authenticate the request.

As a result of authentication, an identity will be established and the application browser platform 256 will append 540 a Person Context 542 to the authenticated request context before moving on to the next step.

Once the application browser platform 256 has established an authenticated request, the identity associated with the request context is compared 560 to the access control list for the application destination. If the user associated with the request does not have access to the application, the request is denied 562.

After authorizing the request, the application browser platform 256 needs to route 564 the request to its destination. For applications hosted directly within the application browser platform 256, the endpoint handler is executed 570 directly. For applications hosted on the intranet, a Kerberos Delegatable ticket is retrieved 572 from the Kerberos Key Distribution Center (KDC) and appended to the request before being proxied 574 on to its destination.

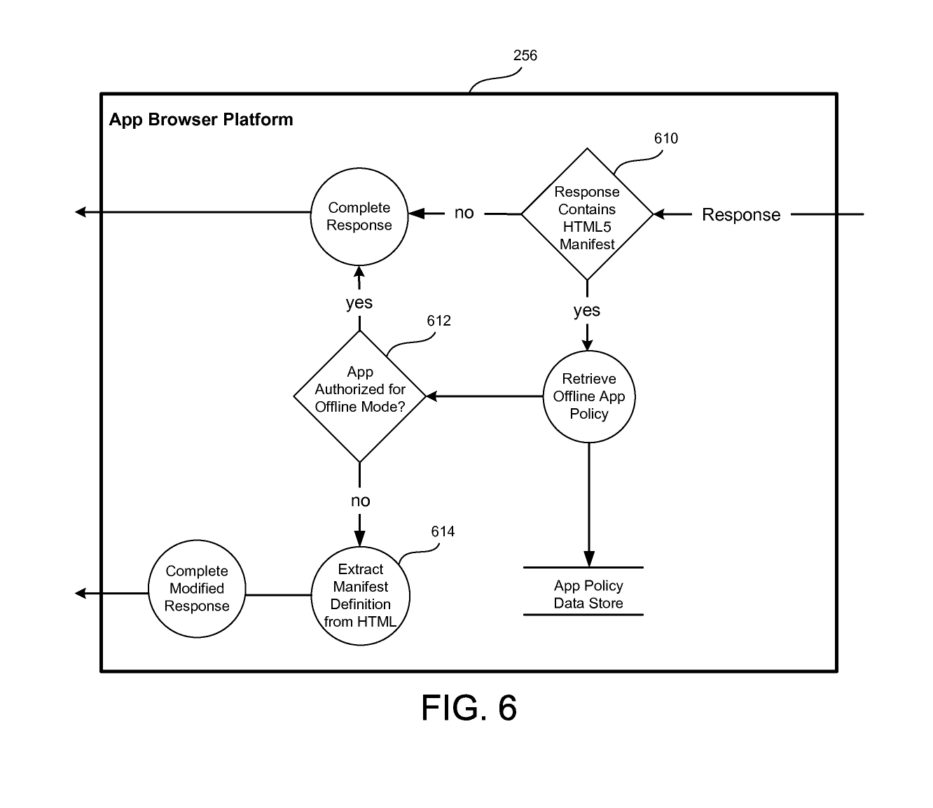

Referring to FIG. 6, responses to the application browser 114 will be inspected 610 for an HTML5 manifest reference. If a manifest reference is detected, the Offline Policy of the Application is checked 612. If the Application is not authorized to work in Offline Mode utilizing HTML5 Application Cache, the manifest will be removed 614 from the response before being sent back to the App Browser.

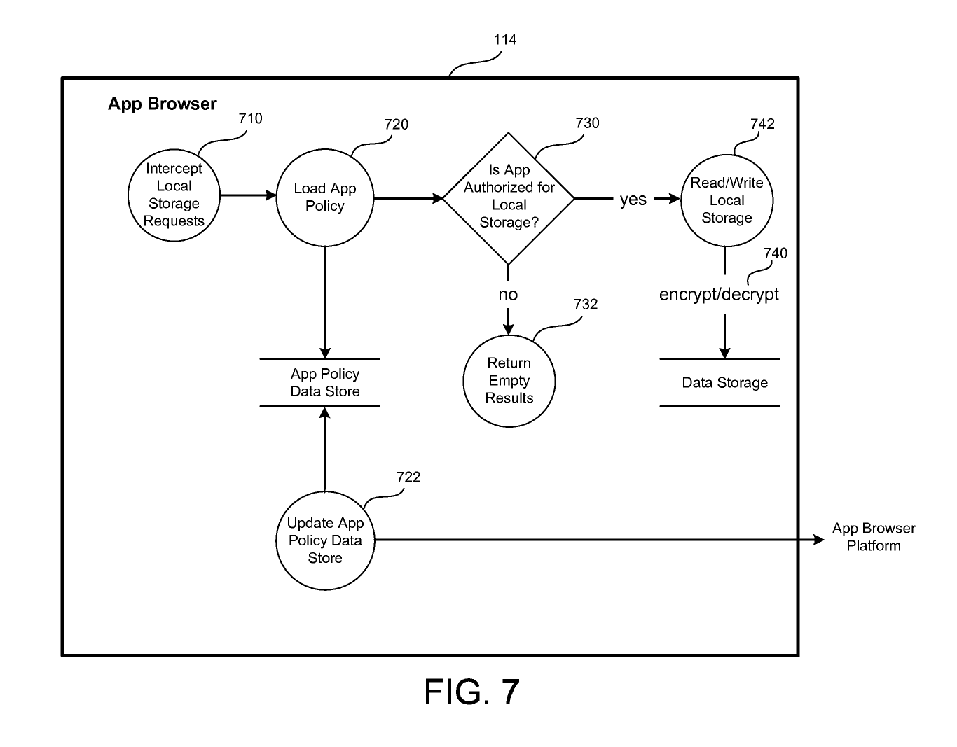

Referring to FIG. 7, JavaScript requests to access local storage will be intercepted 710 by overriding the JavaScript local storage functions in the iOS application browser 114 implementation. Through this approach, the application browser 114 will be able to rewrite local storage requests to target a custom application browser 114 end point handler.

Once the local storage request is intercepted, the custom end point handler is responsible for loading 720 up the local storage policy from the current application. The application policy store is regularly synced 722 from the application browser platform 256 to maintain the most current policy rules. If the application is not authorized to use local storage 730, any requests to retrieve data will return with empty results 732 as if the cache is constantly cleared.

This approach may be chosen over using the HTML5 spec-based Security Exception for policy to better support existing HTML5 applications. On iOS devices, currently there is no option to disable local storage within the browser. It is assumed that not all applications were coded to specification, but all applications would need to be coded to support empty local storage results.

Authorized Local Storage access is decrypted/encrypted 740 on read and write operations 742 respectively. This ensures that all cached data is secured on the mobile device 110 at rest.

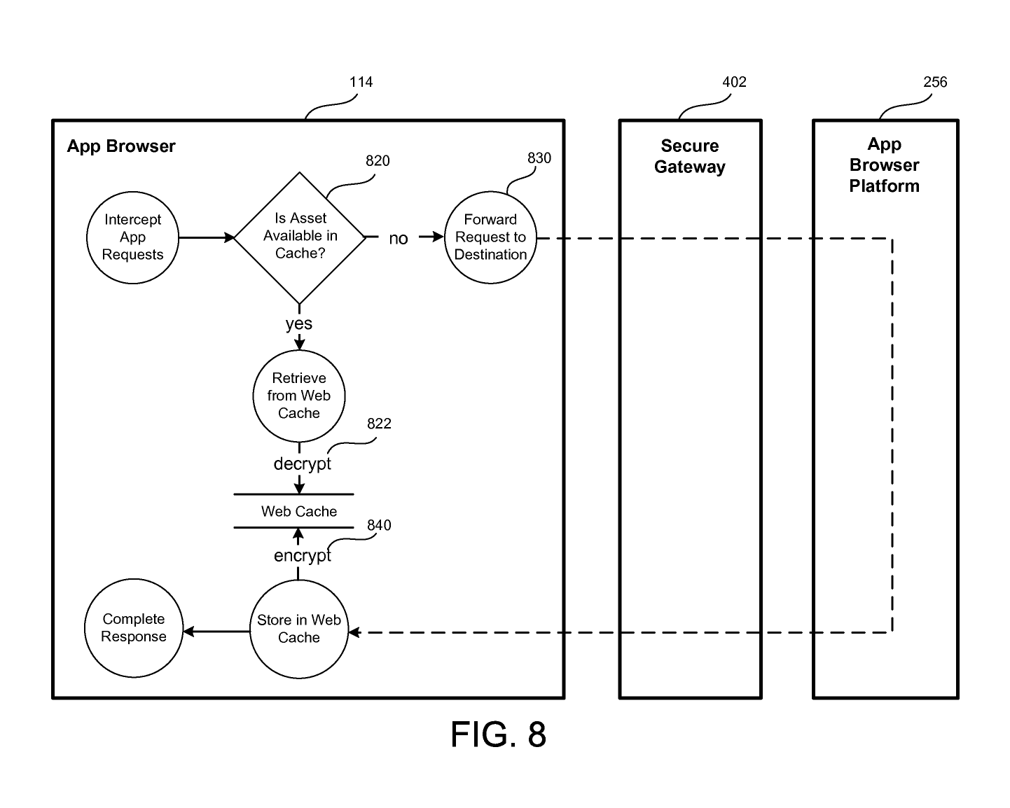

Referring to FIG. 8, caching assets locally is a standard practice for all modern browsers and is a part of the normal web request flow for an Application in the App Browser. iOS allows app developers to extend the default implementation and supply their own. The application browser 114 will use an extension of the standard web cache implementation in iOS to encrypt assets stored in the web cache.

If assets are found in the web cache 820 via the application browser 114 extended web cache handler, they will be decrypted 822 and used to render the application within the application browser 114 directly. If the asset is not found in cache, the request continues along the standard application browser 114 request flow 830 and during the response, the asset will be encrypted 840 and entered into cache.

The container application 112 may display one or more user authorized enterprise web applications 154 when a user of the mobile device 110 has been authenticated and verified. A method for displaying the enterprise web application 154 after the content of the application 154 has been fully downloaded and rendered on the display 124 of the mobile device 110 may include observing network connections made by the application 154 and, upon completion of connection requests, revealing the application 154 to the user. During application rendering a loading screen may be shown to the user on the display 124 of the mobile device 110 for a native effect.

The foregoing description of the present invention has been presented for purposes of illustration and description. Furthermore, the description is not intended to limit the invention to the form disclosed herein. For example, although various features and aspects of the various embodiments may be described and depicted herein in connection with particular mobile devices (e.g. Apple iPhone and iPad running iOS), such features and aspects are not necessarily limited to implementation on such devices only and may be implemented on devices from other manufacturers running other operating systems.

Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. While various embodiments of the present invention have been described in detail, further modifications and adaptations of the invention may occur to those skilled in the art. However, it is to be expressly understood that such modifications and adaptations are within the spirit and scope of the present invention.

What is claimed is:

1. A system for secure access to data and services of an enterprise information technology system, said system comprising:
a mobile device including at least one processer;
a container application installed on said mobile device and executable by said at least one processor, said container application securely connecting the mobile device with an enterprise proxy server included in the enterprise information technology system when executed by said at least one processor;
an application browser embedded in said container application; and
one or more web applications included in the enterprise information technology system and mapped by the enterprise proxy server for access by said application browser;
wherein said container application launches said embedded application browser to request from said proxy server at least one of said one or more web applications for execution by said embedded application browser within said container application, and wherein data said container application encrypts data associated with said at least one of said one or more web applications and stored locally on said mobile device.

2. The system of claim 1, wherein said container application is further enabled to cache said at least one of said one or more web applications locally within said container application for off-line execution by said embedded application browser.

3. The system of claim 1, wherein said container application is further enabled to delete the data associated with said at least one of said one or more web applications and stored locally on said mobile device.

4. The system of claim 1, further comprising:
a private network operative to securely communicate data between said container application and said proxy server, wherein said proxy server is only accessible via said container application.

5. The system of claim 4, wherein the data securely communicated between said container application and said enterprise proxy server comprises data associated with said at least one of said one or more web applications.

6. The system of claim 4, wherein the data securely communicated between said container application and said proxy server comprises data associated with authentication and verification of a user of said mobile device.

7. The system of claim 1, wherein said container application is further enabled to manage authentication and verification of a user of said mobile device.

8. The system of claim 7, wherein said container application is further enabled to display a catalog of said one or more web applications authorized for access by the user of said mobile device when the user of the mobile device has been authenticated and verified.

9. The system of claim 1, wherein said one or more web applications are implemented in HTML5 and said application browser comprises an HTML5 enabled browser.

10. A method for secure remote to data and services of an enterprise information technology system, said method comprising:
securely connecting a mobile device for communication with an enterprise proxy server included in the enterprise information technology system using a container application installed on the mobile device, the container application including an embedded application browser;
launching the embedded application browser to request from the proxy server at least one of one or more web applications included in the enterprise information technology system and mapped by the proxy server for access by the application browser;
executing on the mobile device the requested at least one of the one or more web applications with the application browser embedded within the client container application; and
encrypting with the container application data associated with the executed at least one of the one or more web applications and stored locally on the mobile device.

11. The method of claim 10, further comprising:
caching the requested at least one of the one or more web applications locally within the container application for off-line execution by the embedded application browser.

12. The method of claim 10, further comprising:
deleting the data associated with the executed at least one of the one or more web applications and stored locally on said mobile device.

13. The method of claim 10, further comprising:
securely communicating data between the container application and the proxy server via a private network, wherein the proxy server is only accessible via the container application.

14. The method of claim 13, wherein the data securely communicated between the container application and the proxy server comprises data associated with the one or more enterprise web applications.

15. The method of claim 13, wherein the data securely communicated between the container application and the enterprise proxy server comprises data associated with authentication and verification of a user of the mobile device.

16. The method of claim 10, further comprising:
executing the container application to manage authentication and verification of a user of the mobile device.

17. The method of claim 16, further comprising:
displaying a catalog of the one or more web applications authorized for access by the user of the mobile device when the user of the mobile device has been authenticated and verified.

18. The method of claim 10 wherein the one or more web applications are implemented in HTML5 and the application browser comprises an HTML5 enabled browser.

19. The method of claim 10 wherein the container application comprises computer readable program code stored in a memory of the mobile device and executable by a processor of the mobile device.

20. Computer-program product comprising:
a non-transitory computer useable medium having computer program code embodied therein, the computer program code including:
computer readable program code enabling a processor of a mobile device to securely connect a mobile device for communication with an enterprise proxy server included in the enterprise information technology system;
computer readable program code enabling a processor of a mobile device to launch an embedded application browser to request from the proxy server at least one of one or more web applications included in the enterprise information technology system and mapped by the proxy server for access by the application browser;
computer readable program code enabling a processor of a mobile device to execute on the mobile device the requested at least one of the one or more web applications with the application browser; and
computer readable program code enabling a processor of a mobile device to encrypt data associated with the executed at least one of the one or more web applications and stored locally on the mobile device.
